(19) United States
(12) Patent Application Publication
(10) Pub. No.: US 2007/0265158 A1
(43) Pub. Date: Nov. 15, 2007

(54) Method of Selectively Applying Carbon Nanotube Catalyst

(75) Inventors: Ayumi Mitsumori, Saitama (JP); Osamu Kumasaka, Saitama (JP); Makoto Okano, Saitama (JP); Tetsuya Imai, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: PIONEER CORPORATION, Tokyo (JP)

(21) Appl. No.: 11/547,105

(22) PCT Filed: Mar. 28, 2005
(86) PCT No.: PCT/JP05/06519

§ 371 Date: Dec. 28, 2006

(30) Foreign Application Priority Data
Mar. 29, 2004 (JP) 2004-094960

(51) Int. Cl. B01J 37/34

(52) U.S. Cl. 502/5; 977/775

(57) ABSTRACT

A method for applying a carbon nanotube growth catalyst to at least one specified location on a substrate surface of a substrate formed of conductive material, and the method includes a preparation step for preparing on the substrate a coating layer having a hole contacting the substrate surface at a location corresponding to the specified location. The method also includes a deposition step for forming by deposition a conical deposited material on a substrate surface portion contacting the hole by irradiating the substrate with electrically conductive material particles in a oblique direction from above the coating layer while rotating the substrate about a shaft perpendicular to the substrate surface, and for forming by deposition an eaves-like deposited layer which extends to close an opening of the hole. The method also includes a determination step for measuring a size of the opening in accordance with extension of the eaves-like deposited layer, and a catalyst applying step for applying the catalyst to a tip of the conical deposited material by way of irradiation of material particles of the catalyst via the opening when the opening is measured to have a specified size.

### TECHNICAL FIELD

The present invention relates to a method of applying a catalyst for growing a carbon nanotube.

### BACKGROUND ART

It is necessary to provide an electron source emitter for electron emission in a field emission display (FED) and an electron beam storage apparatus. A mechanism of the electron emission from the electron source emitter is based on a field emission phenomenon which is different from the thermoelectronic emission observed in a conventional CRT. The field emission is caused by application of a strong electric field to a solid surface, which decreases thickness of a potential barrier and reduces the potential barrier. As a result, an electron in the solid surface is emitted into a vacuum due to tunnel effect. In order to achieve such field emission, it is necessary to apply a very strong voltage across the solid. In this case, when an area to which the voltage is applied is reduced, for example, by forming an electron source emitter to have a metallic needle shape with an acute tip, the electric field may be concentrated due to such area reduction, making it possible to reduce the voltage.

In consideration of the above-described voltage reduction, it may be worth consideration to form the tip of the electron source emitter by using a carbon nanotube (hereinafter referred to as a CNT). The carbon nanotube not only has an excellent electric conducting property, but also has a very large aspect ratio to provide an acute tip. Moreover, the carbon nanotube is chemically stable and mechanically robust. Accordingly, the carbon nanotube has advantages when it is used as the tip of the electron source emitter. However, only one nanotube cannot afford to discharge a large number of electrons, which results in only a small amount of electric current. Therefore, a nanotube array is generally used when the nanotube is applied as a field emission type electron source. The nanotube array represents a large number of nanotubes which are respectively mounted on tips of a plurality of emitters arranged like a pinholder for ikebana.

Methods of selective growth of the carbon nanotubes on the tips of the plurality of emitters are disclosed in a nonpatent literature 1 and a nonpatent literature 2. The nonpatent literature 1 discloses a method in which a catalyst is attached on an entire surface of an emitter chip, and then CVD (Chemical Vapor Deposition) is carried out while applying an electric field in a direction perpendicular to a substrate. Consequently, the CNT selectively grows at a tip of the chip where the electric field is concentrated. Alternatively, it is effective to apply a CNT growth catalyst on each of the tips of the emitters. In a method disclosed in the nonpatent literature 2, a Ni metal serving as the catalyst is arranged on a desired location by means of an FIB (Focused Ion Beam), which makes it possible to cause selective CNT growth on the location.

Nonpatent Literature 1

“Electric-field-enhanced growth of carbon nanotube for scanning probe microscopy”, Takahito Ono, et. al, Nanotechnology, 13 (2002) 62-64.

Nonpatent Literature 2

“Carbon nanotube Growth on Nickel Implanted Nanopyramids Array (NPA)”, D. Ferrer, T. Shinada, T. Tanji, G. Zhong, J. Kurosawa, Y Kubo, K. Imamura, H. Kawarada, I. Ohdomari, 9th international conference on the formation of semiconductor interfaces, Madrid, Sep. 15-19, 2003.

### DISCLOSURE OF INVENTION

### Problem to be Solved by the Invention

However, the method disclosed in the nonpatent literature 1 has a problem in that a growth point of the CNT depends on a shape of the substrate which determines electric field distribution, because a catalyst thin film is applied on an entire surface of the substrate. Furthermore, when a contamination such as a dust exists, the electric field is concentrated thereto, which becomes a point where the CNT grows. On the other hand, the method disclosed in the nonpatent literature 2 has a problem in that the FIB must be precisely positioned onto the tip of the emitter chip, since the CNT growth catalyst is directly applied by the FIB.

An object of the present invention is to provide a catalyst applying method which can precisely and easily select the growth location of the carbon nanotube.

### Measure Taken to Solve the Problem

A catalyst applying method set forth in claim 1 provides a method for applying a carbon nanotube growth catalyst to at least one specified location on a substrate surface of a substrate formed of conductive material, the method comprising the steps of a preparation step for forming a coating layer on the substrate surface and for preparing on said substrate a coating layer having a hole contacting said substrate surface at a location corresponding to said specified location; a deposition step for forming a conical deposited material by deposition on a substrate surface portion contacting said hole by irradiating said substrate with electrically conductive material particles in a oblique direction from above said coating layer while rotating said substrate about a shaft perpendicular to said substrate surface, and for forming by deposition an eaves-like deposited layer which extends to close an opening of said hole; a determination step for measuring a size of said opening in accordance with extension of said eaves-like deposited layer; and a catalyst applying step for applying said catalyst to a tip of said conical deposited material by way of irradiation of material particles of said catalyst via said opening when said opening has been measured to have a specified size.

A catalyst applying method set forth in claim 7 includes a method of forming a field emission projection on at least one specified location of substrate surface of substrate formed of conductive material and applying carbon nanotube growth catalyst at said field emission projection, the method comprising the steps of a preparation step for preparing on said substrate a coating layer having a hole contacting said substrate surface at a location corresponding to said specified location; a deposition step for forming by deposition a conical deposited material as said field emission projection on a substrate surface portion contacting said hole by irradiating said substrate with electrically conductive material particles in a oblique direction from above said coating layer while rotating said substrate about a shaft perpendicular to said substrate surface, and for forming by deposition an eaves-like deposited layer which extends to close an opening of said hole; a determination step for measuring a size of said opening in accordance with extension of said eaves-like deposited layer; and a catalyst applying step for applying said catalyst to a tip of said conical deposited material by way of irradiation of material particles of said catalyst via said opening when said opening has been measured to have a specified size.

### BRIEF DESCRIPTION OF DRAWINGS

FIG. 1A is a schematic cross sectional view of a substrate in a preparation step in accordance with a first embodiment of the present invention.

FIG. 1B is a schematic cross sectional view of a substrate in a deposition step in accordance with the first embodiment of the present invention.

FIG. 1C is a schematic cross sectional view of a substrate in a determination step in accordance with the first embodiment of the present invention.

FIG. 1D is a schematic cross sectional view of a substrate in a catalyst step in accordance with the first embodiment of the present invention.

FIG. 1E is a schematic cross sectional view of a substrate in a final step in accordance with the first embodiment of the present invention.

FIG. 2 is a schematic cross sectional view of a substrate in a initial step in accordance with a second embodiment of the present invention.

FIG. 3A is a schematic cross sectional view of a substrate in a deposition step in accordance with a third embodiment of the present invention.

FIG. 3B is a schematic cross sectional view of a substrate in a catalyst applying step in accordance with the third embodiment of the present invention.

FIG. 4 is a schematic cross sectional view of a substrate in accordance with a fourth embodiment of the present invention.

### MODES FOR CARRYING OUT THE INVENTION

Embodiments of the present invention will be hereinafter described in detail with reference to the accompanying drawings.

### First Embodiment

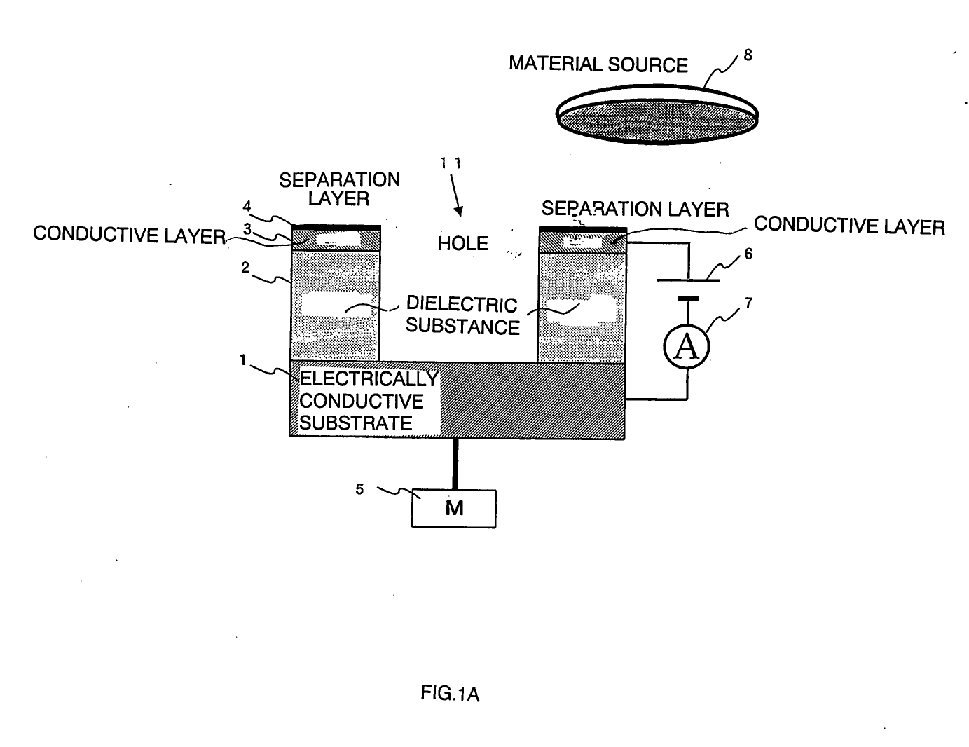

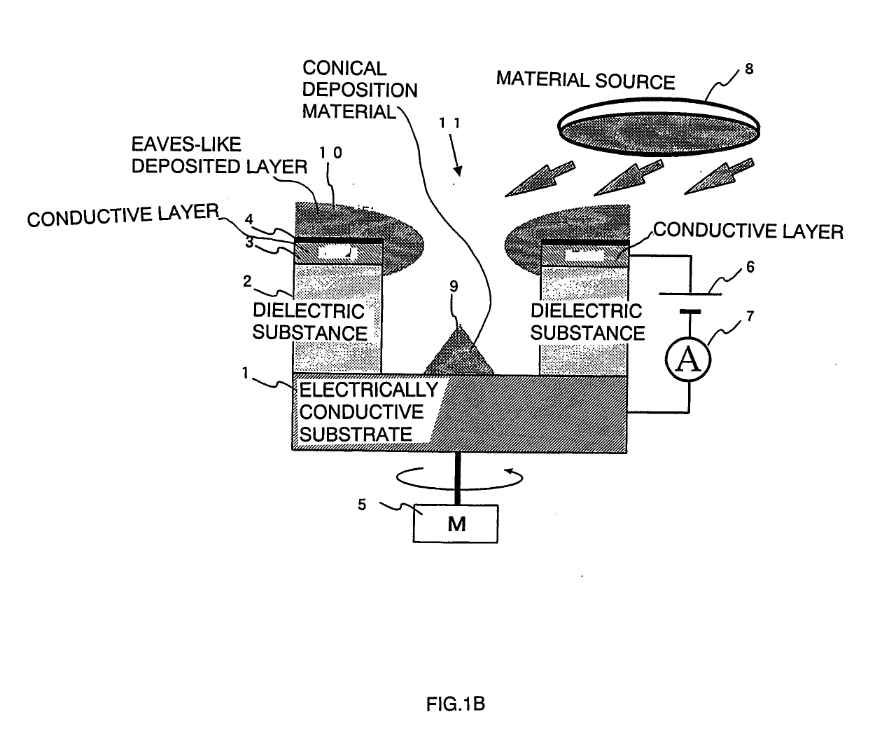

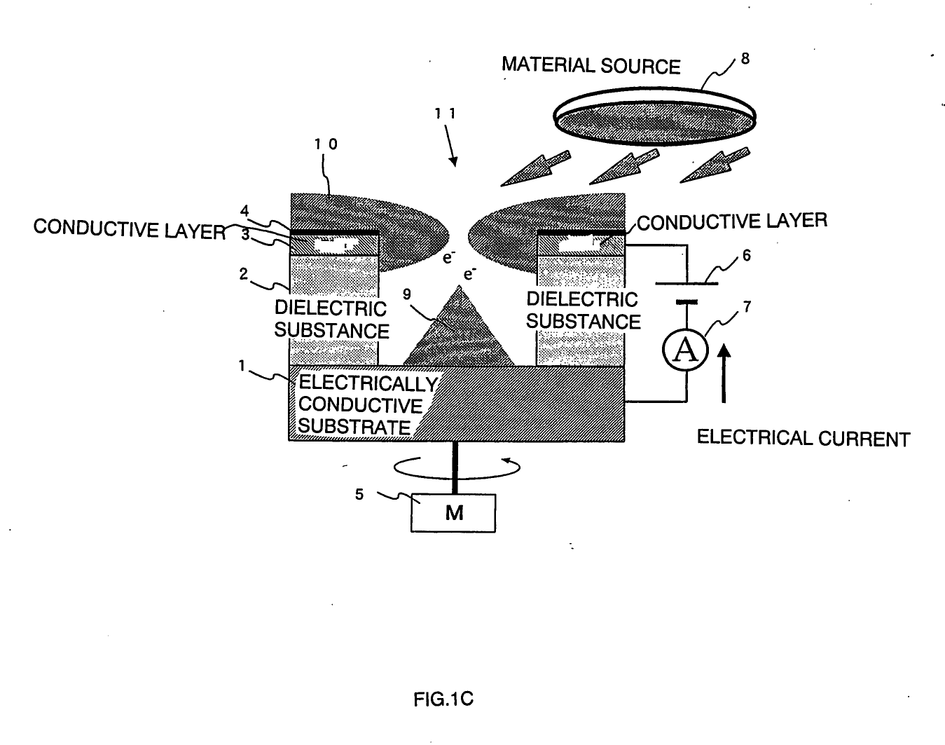

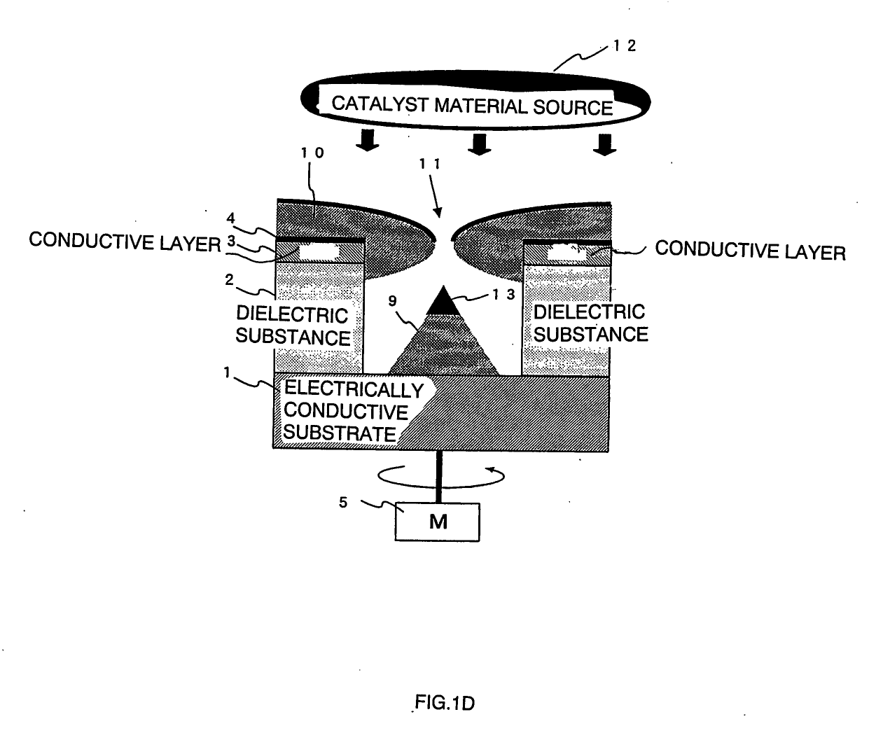

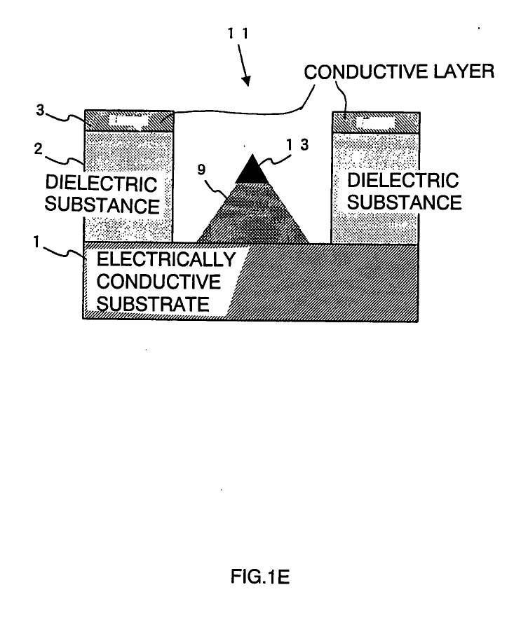

FIG. 1A to FIG. 1E illustrate a catalyst applying method in accordance with a first embodiment of the present invention. FIG. 1A shows a state of a preparation step in which an apparatus for performing the catalyst applying method and a substrate are prepared. The apparatus includes an electrically conductive substrate 1 such as Si substrate, a substrate-rotation motor 5 for rotating the electrically conductive substrate 1, a DC power 6, an ampere meter 7, and a material source 8 for forming an emitter and an opening. On the electrically conductive substrate 1, dielectric layer 2, a conductive layer 3, and a separation layer 4 are sequentially formed, and a hole 11 is sandwiched between these layers in cross section. After materials respectively corresponding to the dielectric layer 2, conductive layer 3 and separation layer 4 are sequentially formed, the hole 11 is formed to have a circular cylinder shape by a photo lithography which performs etching to create a circle that is parallel to a surface of the electrically conductive substrate 1. The materials for the dielectric layer 2, conductive layer 3 and separation layer 4 may be, for example, SiO2, Al and resist resin, respectively. It should be noted that even though only one hole 11 of the circular cylinder shape is shown in this embodiment for the purpose of easy description, a large number of holes may be formed in a matrix pattern on the electrically conductive substrate 1.

The rotation motor 5 rotates the electrically conductive substrate 1 at a constant rotating speed about a shaft perpendicular to the surface of the electrically conductive substrate 1. With this arrangement, even though the hole 11 is irradiated with particles in a constant oblique direction from above the electrically conductive substrate 1, an inside wall of the hole 11 can be uniformly irradiated. The DC power 6 applies the voltage between the electrically conductive substrate 1 and the conductive layer 3 by connecting a positive electrode thereof to the electrically conductive substrate 1 and connecting a negative electrode thereof to the conductive layer 3 via the ampere meter 7. The ampere meter 7 measures an electric current of the field emission electrons flowing between the electrically conductive substrate 1 and the conductive layer 3. The material source 8 for providing a minute opening is made of a conductive material which is used to form an eaves-like deposited layer providing an opening at the vicinity of the top of the hole 11, and also it is used to form a conical deposited material serving as an emitter at the bottom of the hole 11 on the electrically conductive substrate 1. The material source 8 is, for example, Cr which cannot be the CNT catalyst. Deflection of an ion beam by using the electric field adjusts the irradiation of the particles supplied from the material source 8 so as to direct the irradiation in a constant oblique direction from above the electrically conductive substrate 1. An angle of the oblique direction of the irradiation is properly determined on the basis of a ratio of height to diameter of the hole 11 having the circular cylinder shape. Consequently, position of the material source 8 is laterally offset along a horizontal direction of the electrically conductive substrate 1 in accordance with a distance between the material source 8 and the electrically conductive substrate 1. It should be noted that the irradiation of the material supplied from the material source 8 may be performed by a vapor deposition apparatus or a sputtering apparatus on condition that the irradiation of the deposited particles can be directed in a specified direction such as the oblique direction.

FIG. 1B shows a state of the deposition step in which deposition material is supplied from the material source 8. In this step, starting from a state shown in FIG. 1A, an eaves-like deposited layer 10 having an eaves-like shape in cross section is formed extending from an upper surface of the separation layer 4 to the conductive layer 3 via an edge portion of the separation layer 4 facing the hole 11. Further, at the bottom of the hole 11, a conical deposited material 9 is formed. The eaves-like deposited layer 10 and the conical deposited material 9 are formed as described above, because the electrically conductive substrate 1 is irradiated with the material supplied from the material source 8 in the oblique direction while the electrically conductive substrate 1 is rotated by the rotation motor 5 as described above. As the irradiation proceeds, such “eaves-like portion” extends toward the center of the hole 11 having the circular cylinder shape. Furthermore, at the bottom of the hole 11 etched by the photo lithography process, a conical deposited material 9 is formed. In this step, the voltage is applied by the DC power 6 between the electrically conductive substrate 1 and the conductive layer 3. Accordingly, an electric field intensity is gradually increased between the eaves-like deposited layer 10 and the conical deposited material 9 which are both electrically conductive. In accordance with the gradual growth of the tip of the conical deposited material 9 to form acute shape, the edge of the “eaves-like portion” of the eaves-like deposited layer 10 extends. When the “eaves-like portion” comes close to the tip of the conical deposited material 9, the electric field intensity therebetween becomes further increased.

FIG. 1C shows a state of a determination step in which the electric current of the field emission electrons is measured. As shown in this figure, when the electric field intensity is sufficiently increased, the tip of the conical deposited material 9 starts emitting an electron, which causes flow of an electric current between the electrically conductive substrate 1 and the conductive layer 3 via the eaves-like deposited layer 10. Monitoring of this electric current by using the ampere meter 7 makes it possible to determine whether the opening of the hole 11 becomes sufficiently small or not. The relationship between an adequacy of applied voltage, and the opening diameter and the electric current value are determined empirically.

FIG. 1D shows a state of a catalyst step in which a catalyst is applied. As shown in this figure, a catalyst material source 12 for CNT growth is positioned at a location with less offset with respect to the electrically conductive substrate 1 as compared with the material source 8 for the deposited layer described above. The electrically conductive substrate 1 is irradiated with catalyst material particles from the catalyst material source 12 through the minute opening of the hole 11. Consequently, a catalyst 13 is selectively applied on a tip portion of the conical deposited material 9 having the conical shape on the electrically conductive substrate 1 such that the catalyst 13 is applied at a region corresponding to the minute opening diameter of the hole 11.

FIG. 1E shows a state of a final step in which the separation layer is removed. As shown in this figure, the separation layer 4 is removed together with the eaves-like deposited layer 10 attached thereto in a cleaning step using an appropriate solvent. Consequently, the conical deposited material 9 is provided with the CNT growth catalyst 13 only within an extremely narrow region, i.e., at the tip portion of the conical shape.

The above-described embodiment presents a configuration which electrically determines whether or not the minute opening portion has a certain area size through which the catalyst can be applied only onto the tip of the conical deposited material serving as the emitter. Accordingly, it becomes possible to adjust the area size which applies the catalyst within a pertinent minute region. Furthermore, during modification of the shape of the opening portion to provide a minute opening, the positional relationship between the substrate and the deposition material source is offset so that a direction of the deposition becomes oblique, whereas during the application of the catalyst, the positional relationship is changed to decrease the amount of the offset as compared with that between the substrate and the deposition material source so as to increase an incident angle toward the substrate. Moreover, size of a target may be decreased, or a distance between the target and the substrate may be increased. Accordingly, it becomes possible to decrease an area where the catalyst material is applied via the minute opening section.

### Second Embodiment

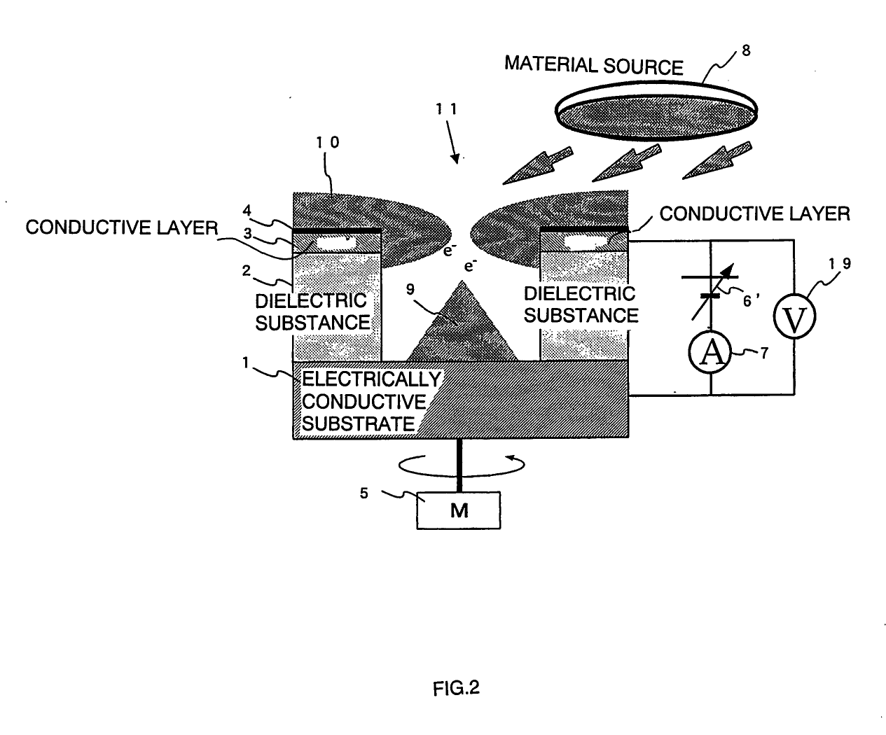

FIG. 2 shows a configuration performing a catalyst applying method according to a second embodiment. In this embodiment, monitoring of the difference of drawing voltages, by which the electron emissions are generated, can identify pertinent timing for the application of the catalyst. As shown in this figure, on the electrically conductive substrate 1, a dielectric layer 2, a conductive layer 3 and a separation layer 4 are deposited which is similar to the first embodiment. In this embodiment, between the electrically conductive substrate 1 and the conductive layer 3, a variable DC power 6′ capable of arbitrary changing the supply voltage is connected to have a pertinent polarity direction with respect to the electrically conductive substrate 1 and the conductive layer 3. A voltmeter 19 and an ampere meter 7 are also connected between the electrically conductive substrate 1 and the conductive layer 3.

In the configuration shown in FIG. 2, by way of a deposition step in which the deposition material is supplied from the material source 8, an eaves-like deposited layer 10 is formed and a conical deposited material 9 is formed at the bottom of the hole 11 which are similar to the first embodiment. During this step, the electrically conductive substrate 1 is rotated by the rotation motor 5. Whereas, a DC voltage adjusted by the variable DC power 6′ is applied between the electrically conductive substrate 1 and the conductive layer 3. In this case, in accordance with growth of a tip of the conical deposited material 9 to form an acute shape, electron emission occurs.

In this instance, adjustment of the voltage of the variable DC power 6′ makes it possible to detect the voltage level at which the field emission occurs which is performed by monitoring the current value of the ampere meter 7. Specifically, at the initial phase of the deposition of the conical deposited material 9, the voltage level necessary to emit an electron is high. However, in accordance with the growth of the tip of the conical deposited material 9 to form an acute shape, concentration of the electric field at the tip becomes strong, and thus the applied voltage necessary to emit an electron is decreased. As described above, the monitor of the applied voltage necessary to emit an electron can not only monitor the acute level of the tip of the conical deposited material 9 on the substrate, but also comprehend the state of the opening diameter of the hole 11. The relationship between the pertinent opening diameter and the starting voltage of the field emission can be determined empirically. Once the pertinent opening diameter is obtained, the catalyst 13 is applied to the conical deposited material 9 which is similar to the first embodiment.

According to the above-described second embodiment, the field emission electron is monitored which is similar to the first embodiment. However, the applied voltage is adjusted so that the electric current value of the field emission electron current does not fluctuate, which is different from the first embodiment. Since the starting voltage of the field emission can be precisely measured, accuracy to measure the opening diameter of the hole 11 is improved.

### Third Embodiment

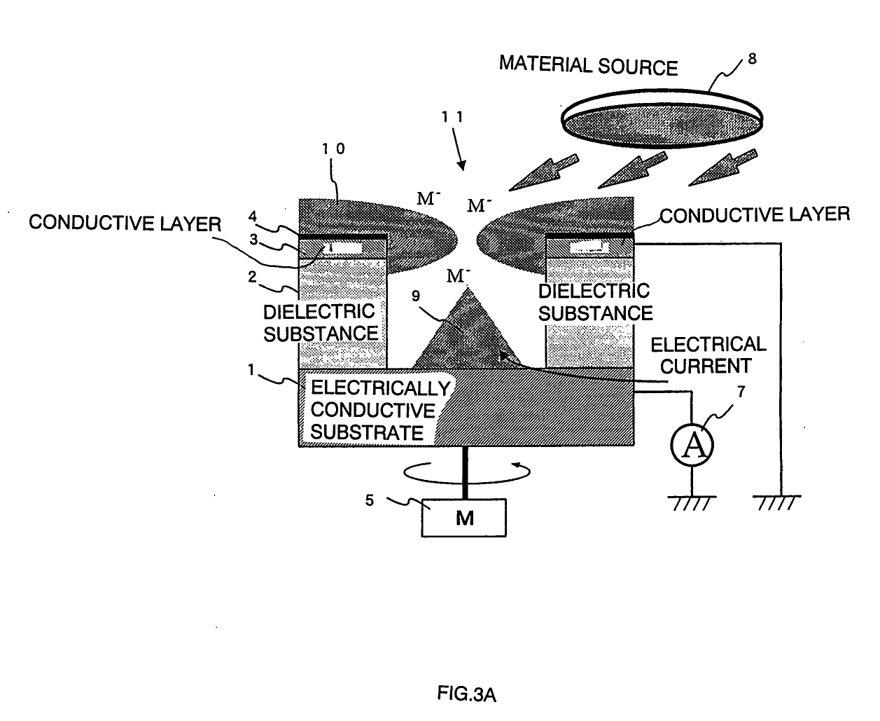

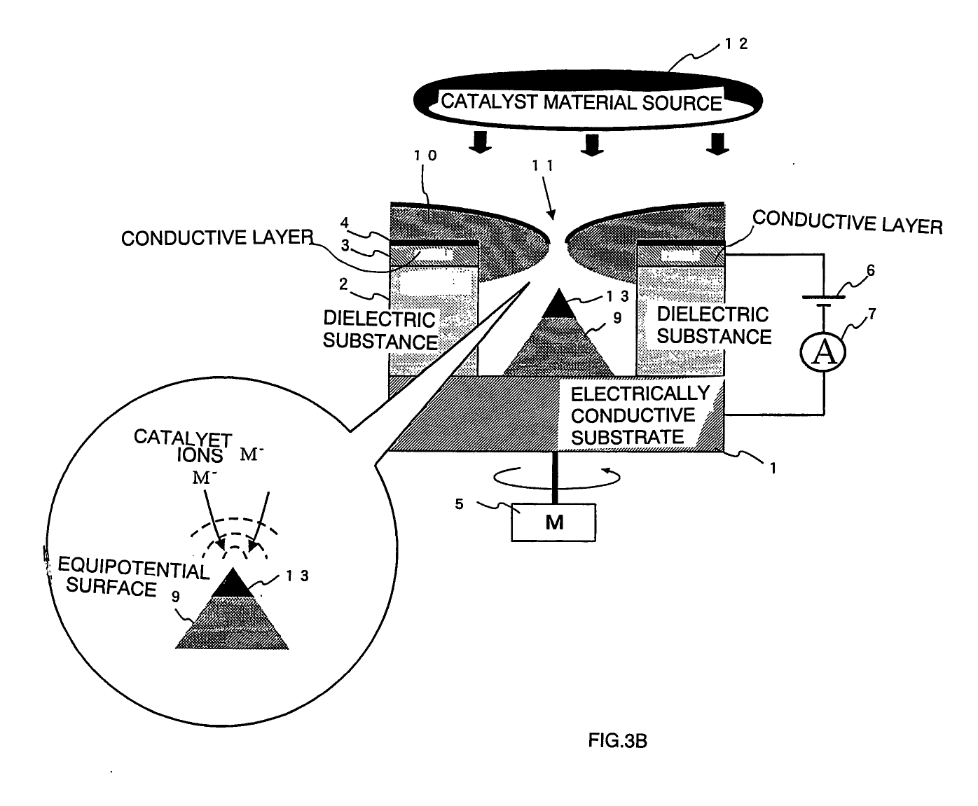

FIGS. 3A to 3B show a configuration performing a catalyst applying method according to a third embodiment. This embodiment presents a configuration to determine the quantity of deposition particles to be attached to the substrate by monitoring charged particles supplied from the material source 8. The deposition particles supplied form the material source 8 are deposited to form an eaves-like deposited layer 10 and a conical deposited material 9 on the electrically conductive substrate 1. In this case, since the electric current represents electric charge which is carried on the deposition particles, detection of the electric current comprehends the amount of particles to be attached.

FIG. 3A shows a structure of the deposition step according to the third embodiment. In this step, a dielectric layer 2, a conductive layer 3 and a separation layer 4 are deposited on the electrically conductive substrate 1 which is similar to the first embodiment. In this embodiment, an electrically conductive substrate 1 is connected to ground via the ampere meter 7, and the conductive layer 3 is also connected to ground. In a structure shown in this figure, irradiation from the material source 8 is performed by the ion plating method, and the deposition is performed in an oblique direction while rotating the electrically conductive substrate 1 by the rotation motor 5. In this instance, the electric charge carried on the deposition particles deposits onto the eaves-like deposited layer 10 and then flows to ground. Whereas the electric charge carried on the deposition particles arriving at the conical deposited material 9 flows to ground via the ampere meter 7. The electric current flowing through the ampere meter 7 decreases as the number of deposition particles arriving at the conical deposited material 9 decreases. This is caused because the opening becomes narrower in accordance with the extension of the eaves-like portion of the eaves-like deposited layer 10 toward the center of the opening of the hole 11. Monitoring of this electric current of the deposition particles by the ampere meter 7 makes it possible to comprehend the state of the opening of the hole 11 having the circular cylinder shape. The relationship between the pertinent opening diameter and the current value of the deposition particle can be determined empirically. Once the pertinent opening diameter is obtained, the catalyst 13 is applied to the conical deposited material 9 which is similar to the first embodiment.

FIG. 3B is a modification of the third embodiment and illustrates the catalyst applying step. In this catalyst applying step, the DC power 6 and the ampere meter 7 are connected in series between the electrically conductive substrate 1 and the conductive layer 3. With this arrangement, electrical potential difference is applied between the electrically conductive substrate 1 and the conductive layer 3. As shown in this figure, since electric field is generated between the electrically conductive substrate 1 and the conductive layer 3, an equipotential surface becomes narrower in accordance with the growth of the conical deposited material 9 to form an acute shape. Consequently, it becomes possible to concentrate the deposition of the deposition particle carrying the electric charge at the tip portion of the conical deposited material 9. Further, monitor of the current value at the ampere meter 7 can comprehend the condition of the deposition.

In the above-described third embodiment, unlike the first and the second embodiments which depend on the electron emission phenomenon, it becomes possible to comprehend the condition of the opening of the hole without depending on the electron emission phenomenon. As shown in the modification, in the catalyst applying step, application of the voltage between the electrically conductive substrate and the conductive layer makes it possible to apply the catalyst at the tip portion of the conical deposited material within the minute region.

### Fourth Embodiment

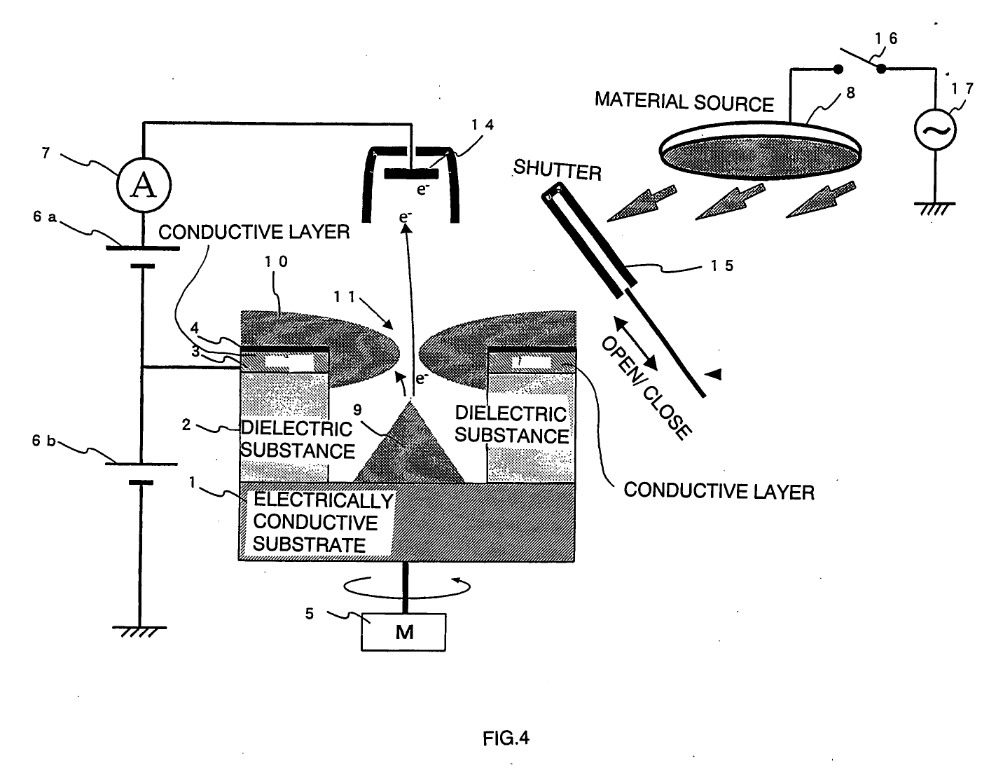

FIG. 4 shows a configuration performing a catalyst applying method according to a fourth embodiment. This embodiment has such configuration that the condition of the minute opening is directly comprehended by means of an anode electrode which captures the field emission electrons discharged through the minute opening of the eaves-like deposited layer. As shown in this figure, a dielectric layer 2, a conductive layer 3 and a separation layer 4 are deposited on the electrically conductive substrate 1 which is similar to the first embodiment. In this embodiment, an anode electrode 14 is provided above the electrically conductive substrate 1 including the dielectric layer 2, the conductive layer 3 and the separation layer 4, and the hole 11 formed therein.

The anode electrode 14 is connected to ground via an ampere meter 7, a DC power 6a and a DC power 6b which are connected in series. The DC power 6a and the DC power 6b apply a positive voltage to the anode electrode 14. A positive electrode of the DC power 6b is connected to the conductive layer 3 so as to apply the positive voltage to the conductive layer 3. With this arrangement, the field emission electrons supplied from the conical deposited material 9 are accelerated by the conductive layer 3 and then captured by the anode electrode 14, thereby generating the electric current. Monitor of this electric current by the ampere meter 7 measures the amount of electrons which can pass through the minute opening of the eaves-like deposited layer among the field emission electrons supplied from the conical deposited material 9.

On the other hand, the material source 8 is provided which is similar to the first and the second embodiments. In this case, when the irradiation of the deposition particle supplied from the material source 8 is performed by the ion plating method similar to the second embodiment, in order to remove the influence by the electrically charged deposition particle, it is necessary prevent the deposition particles from being influenced by the anode electrode 14 during the measurement of the electric current of the field emission electrons, by providing a shutter 15 between the material source 8 and the substrate. Further, it is preferable to provide a switch 16 between the material source 8 and the power source 17 so as to turn on or off the irradiation from the material source 8, which can alternately perform the determination step of the electric current of the field emission electrons and the deposition step of the deposition material supplied from the material source 8.

In the configuration shown in the figure, irradiation from the material source 8 is performed by the vapor deposition, sputtering or ion plating method, and the deposition is performed in a oblique direction while rotating the electrically conductive substrate 1 by the rotation motor 5. When the deposition is performed by the vapor deposition or sputtering, the electric current of the field emission electrons is measured at the same time with the deposition by using the ampere meter 7. When the deposition is performed by the ion plating method, the electric current of the field emission electrons is measured while closing the shutter 15 for the material source 8 and turning off the switch 16. Most of the field emission electrons supplied from the conical deposited material 9 are captured by the conductive layer 3 and the eaves-like deposited layer 10 and then disappear, however some of the field emission electrons are accelerated by the applied voltage to the conductive layer 3 and then discharged toward outside through the minute opening of the hole 11 having the circular cylinder shape. Thereafter, the accelerated electrons are captured by the anode electrode 14 to generate an electric current. The electric current measured by the ampere meter 7 increases in accordance with the growth of conical deposited material 9 to form an acute shape. However, the electric current turns to decrease when the minute opening diameter of the hole 11 having the circular cylinder shape decreases in accordance with the extension of the eaves-like portion of the eaves-like deposited layer 10 toward the center of the opening of the hole 11 having the circular cylinder shape. This is because the electrons are captured by the eaves-like deposited layer 10. Accordingly, monitor of the electric current of the electrons captured by the anode electrode 14 can comprehend the condition of the opening of the hole 11 having the circular cylinder shape. The relationship between the pertinent opening diameter and the current value of the deposition particle can be determined empirically. When the pertinent opening diameter is obtained, the catalyst can be applied to the conical deposited material 9 which is similar to the first embodiment.

In the above-described fourth embodiment, amount of the electrons passing through the minute opening section is measured, and therefore the condition of the opening diameter can be directly comprehended.

As readily understood from the above embodiments, by performing the present invention, it becomes possible to selectively apply the catalyst on the point where the CNT growth is desired. The configuration of the minute opening providing a region to apply the catalyst makes it possible to accurately adjust the location where the catalyst is applied and to apply the catalyst without being affected by the contamination. The location of the hole where the minute opening is provided is formed by a mask in the photo lithography process. Accordingly, the catalyst can be applied on any location. Further, the application of the catalyst can be performed to a whole surface of the substrate which is similar to the conventional art, and therefore the present invention can be easily performed. Moreover, even though a field emission array is manufactured to have a large number of emitters in an array pattern, the catalyst can be applied to the whole emitters in just one step.

### INDUSTRIAL APPLICABILITY

The above embodiments have been described based on methods and apparatuses which selectively apply the carbon nanotube growth catalyst to the field emission source in any location on the substrate. These methods and apparatuses can be utilized to any technical fields where selective growth of the carbon nanotube on the substrate is required. For example, these methods and apparatuses can be utilized to a field emission display (FED), a field emission type imaging device, and any other apparatuses using the field emission source.

### Explanation of Reference Numerals

1 electrically conductive substrate
2 dielectric substance
3 conductive layer
4 separation layer
5 rotation motor
6, 6a, 6b, 6′ DC power
7 ampere meter
8 material source
9 conical deposited material
10 eaves-like deposited layer
11 hole
12 catalyst material source
13 catalyst
14 anode electrode
15 shutter
16 switch
17 power source
19 voltmeter

1. A method for applying a carbon nanotube growth catalyst to at least one specified location on a substrate surface of a substrate formed of conductive material, the method comprising the steps of:
a preparation step for preparing on said substrate a coating layer having a hole contacting said substrate surface at a location corresponding to said specified location;
a deposition step for forming a conical deposited material by deposition on a substrate surface portion contacting said hole by irradiating said substrate with electrically conductive material particles in a oblique direction from above said coating layer while rotating said substrate about a shaft perpendicular to said substrate surface, and for forming by deposition an eaves-like deposited layer which extends to close an opening of said hole;
a determination step for measuring a size of said opening in accordance with extension of said eaves-like deposited layer; and
a catalyst applying step for applying said catalyst to a tip of said conical deposited material by way of irradiation of material particles of said catalyst via said opening when said opening has been measured to have a specified size.

2. The catalyst applying method according to claim 1, wherein said determination step includes a step for measuring an electric current caused by field emission electrons discharged from said conical deposited material and captured by said eaves-like deposited layer.

3. The catalyst applying method according to claim 1, wherein said determination step includes a step for measuring a field emission starting voltage which generates field emission electrons discharged from said conical deposited material and can be captured by said eaves-like deposited layer.

4. The catalyst applying method according to claim 1, wherein said determination step includes a step for measuring an electric current generated by field emission electrons discharged from said conical deposited material and captured by an outside electrode via said opening.

5. The catalyst applying method according to claim 1, wherein said determination step includes a step for measuring an electric current generated when said conical deposited material captures electrical charge carried on said electrically conductive material particles.

6. The catalyst applying method according to claim 1, wherein said catalyst applying step includes a step for collecting ionized material particles of said catalyst at a tip of said conical deposited material by means of an electric potential distribution induced by voltage application between said conical deposited material and said eaves-like deposited layer.

7. A method of forming a field emission source on at least one specified location of substrate surface of substrate formed of conductive material and applying carbon nanotube growth catalyst at said field emission source, the method comprising the steps of:
a preparation step for preparing on said substrate a coating layer having a hole contacting said substrate surface at a location corresponding to said specified location;
a deposition step for forming by deposition a conical deposited material as said field emission source on a substrate surface portion contacting said hole by irradiating said substrate with electrically conductive material particles in a oblique direction from above said coating layer while rotating said substrate about a shaft perpendicular to said substrate surface, and for forming by deposition an eaves-like deposited layer which extends to close an opening of said hole;
a determination step for measuring a size of said opening in accordance with extension of said eaves-like deposited layer; and
a catalyst applying step for applying said catalyst to a tip of said conical deposited material by way of irradiation of material particles of said catalyst via said opening when said opening has been measured to have a specified size.
